(19) United States
(12) Patent Application Publication
(10) Pub. No.: US 2025/0216285 A1
(43) Pub. Date: Jul. 3, 2025

(54) COMPACT EVAPORATIVE EMISSIONS LEAK CHECK MODULE

(71) Applicants: Stoneridge Asia Pacific Electronics (Suzhou) Co. Ltd., Suzhou (CN); Stoneridge Control Devices, Inc., Novi, MI (US)

(72) Inventors: Wells Jiang, Suzhou (CN); Sean Gao, Suzhou (CN); Terry Yu, Suzhou (CN)

(21) Appl. No.: 18/621,492

(22) Filed: Mar. 29, 2024

(30) Foreign Application Priority Data
Dec. 29, 2023 (CN) 2023118618648

(51) Int. Cl. G01M 3/26; G01M 3/02

(52) U.S. Cl. CPC G01M 3/26; G01M 3/025

(57) ABSTRACT

A leak detection module (LDM) includes a housing including first and second valve cavities respectively having first and second walls respectively extending to first and second openings. The first and second walls respectively include first and second holes. The housing has an atmospheric port, a charcoal canister port, and an electrical connector. First and second solenoid valves are arranged within the housing and are respectively received in the first and second cavities and extend out of the first and second openings. A pump is arranged within the housing and includes first and second pump ports respectively coupled to the first and second holes. An electrical connector assembly is arranged within the housing and is coupled to the electrical connector. The electrical connector assembly is electrically connected to the first and second solenoid valves, and the pump.

### PRIORITY CLAIM

This application claims priority to Chinese Patent Application No. 2023118618648 filed Dec. 29, 2023.

### TECHNICAL FIELD

This disclosure relates to a leak detection module (LDM) for an evaporative emissions system. In one example, the disclosure relates to an LDM controller and a method for assembling the LDM.

### BACKGROUND

Evaporative emissions systems have long been required for gasoline powered vehicles. The system must undergo a periodic leak test during or after a vehicle drive cycle to ensure that fuel vapors will not leak into the atmosphere. The gasoline engine, a pump, or fuel tank temperature change is used either to create a vacuum or pressurize the system. Various valves may be closed during this test procedure to maintain system pressure, and the pressure is monitored to determine if there are any leaks.

One type of evaporative emissions system uses a leak detection module (LDM) that typically houses a pump and one or more valves that are operated during a test procedure. Two two-way valves are commonly used in an LDM to regulate flow from the pump and relative to atmosphere. Some LDMs have relatively large packaging and/or may take longer to assembly than desired.

### SUMMARY

In one exemplary embodiment, a leak detection module (LDM) includes a housing having first and second valve cavities respectively including first and second walls respectively extending to first and second openings. The first and second walls respectively include first and second holes. The housing has an atmospheric port, a charcoal canister port, and an electrical connector. First and second solenoid valves are arranged within the housing and are respectively received in the first and second cavities and extend out of the first and second openings. A pump is arranged within the housing and includes first and second pump ports respectively coupled to the first and second holes. An electrical connector assembly is arranged within the housing and is coupled to the electrical connector. The electrical connector assembly is electrically connected to the first and second solenoid valves, and the pump.

In a further embodiment of any of the above, each of the first and second solenoid valves forms a first and second chamber with its respective first and second valve cavity. Both of the first chambers of the first and second cavities are in fluid communication with the charcoal canister port. At least one of the second chambers of the first and second cavities is selectively in fluid communication with the atmospheric port.

In a further embodiment of any of the above, each of the second chambers is bounded by a first and second valve seal arranged between its respective first and second solenoid valve at its respective first and second valve cavity.

In a further embodiment of any of the above, the first and second solenoid valves are 2-position valves having open and closed positions. Each of the first and second solenoid valves are configured to fluidly connect its respective first and second chambers of the its respective first and second valve cavity in the open position. The LDM includes three operational states comprising: a non-operational state in which both the first and second solenoid valves are open; a pressure mode during a testing state in which the first solenoid valve is closed and the second solenoid valve is open, the first solenoid valve fluidly blocking the fluid flow between the charcoal canister port and the atmospheric port via the first chamber of the first valve cavity, and the pump is configured to move fluid between the canister and atmospheric ports; and a pressure-hold mode during the testing state in which the both the first and second solenoid valves are closed.

In a further embodiment of any of the above, the first and second pump ports and the first and second holes are nested relative to one another with a first and second seal respectively therebetween.

In a further embodiment of any of the above, the housing includes first and second housing portions secured to one another to enclose the first and second solenoid valves, the pump and the electrical connector assembly. The first and second walls and the charcoal canister port are provided by the first housing portion, and the electrical connector is provided by the second housing portion.

In a further embodiment of any of the above, the pump includes pump electrical terminals extending in a first direction, and the first and second solenoid valves include valve electrical terminals extending in the first direction. The electrical connector assembly includes an insertion direction opposite the first direction and from which the electrical connector assembly is configured to be pushed into engagement with the pump and valve electrical terminals.

In a further embodiment of any of the above, the electrical connector assembly includes electrical connector terminals extending in the first direction and extending into the electrical connector in an assembled position.

In a further embodiment of any of the above, the electrical connector assembly includes a printed circuit board (PCB) having slots receiving the pump and valve electrical terminals.

In another exemplary embodiment, a method of assembling a leak detection module (LDM) includes inserting first and second solenoid valves respectively into first and second valve cavities in a first housing portion. The first and second valve cavities are respectively provided by first and second walls respectively including first and second holes. A pump having first and second pump ports respectively into the first and second holes is installed. An electrical connector assembly is pushed onto electrical terminals of the first and second solenoid valves, and of the pump. A second housing portion is secured to the first housing portion to enclose the first and second solenoid valves, the pump and the electrical connector assembly.

In a further embodiment of any of the above, the inserting step is performed in an insertion direction to insert the first and second valves respectively through first and second openings respectively in the first and second walls, wherein each of the first and second solenoid valves include first and second valve seals that are seated against its respective first and second cavity to form first and second chambers in each of the first and second cavities.

In a further embodiment of any of the above, the installing step includes pushing the first and second pump ports respectively together the first and second holes in a transverse direction to the insertion direction.

In a further embodiment of any of the above, the pushing step includes pushing the electrical connector assembly in the insertion direction to simultaneously electrically engage the electrical terminals of the first and second solenoid valves, and of the pump.

In a further embodiment of any of the above, the installing step includes mounting the second housing portion to the first housing portion in the insertion direction, and simultaneously extending electrical connecter terminals into an electrical connector provided on the second housing portion.

In a further embodiment of any of the above, the first housing portion has a charcoal canister port, and one of the first and second housing portions has an atmospheric port. Both of the first chambers of the first and second cavities are in fluid communication with the charcoal canister port, and at least one of the second chambers of the first and second cavities selectively in fluid communication with the atmospheric port. The first and second solenoid valves are 2-position valves having open and closed positions, and each of the first and second solenoid valves are configured to fluidly connect its respective first and second chambers of the its respective first and second valve cavity in the open position. The LDM includes three operational states comprising: a non-operational state in which both the first and second solenoid valves are open; a pressure mode during a testing state the first solenoid valve is closed and the second solenoid valve is open, the first solenoid valve fluidly blocking the fluid flow between the charcoal canister port and the atmospheric port via the first chamber of the first valve cavity, and the pump is configured to move fluid between the canister and atmospheric ports; and a pressure-hold mode during the testing state in which the both the first and second solenoid valves are closed.

### BRIEF DESCRIPTION OF THE DRAWINGS

The disclosure can be further understood by reference to the following detailed description when considered in connection with the accompanying drawings wherein:

FIG. 1 schematically illustrates portions of one example evaporative fuel system.

FIG. 2 is a schematic of a leak detection module (LDM) having two solenoid valves and a pump.

FIG. 3 is an exploded view of one example LDM.

FIG. 4 is a perspective view of the LDM show in FIG. 3 mounted in a secondary housing.

FIG. 5 is a cross-sectional view of the LDM in FIG. 4 with in a non-operational state.

FIG. 6 is a cross-sectional view of the LDM in FIG. 4 with in a vacuum mode during a testing state.

FIG. 7 is a cross-sectional view of the LDM in FIG. 4 with in a pressure-hold mode during the testing state.

FIG. 8 is a perspective view of the solenoid valves and pump assembly for another example LDM.

FIG. 9 is a perspective view of a housing portion of the other example LDM for use with the solenoid valves and pump assembly shown in FIG. 8.

FIG. 10 is a perspective view of the other example LDM with another housing portion secured to the housing portion shown in FIG. 9 over the solenoid valves and pump assembly shown in FIG. 8.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

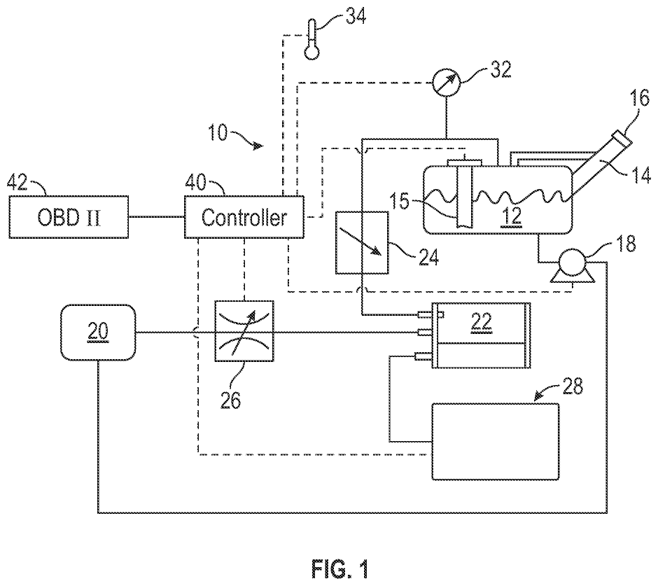

FIG. 1 schematically illustrates a portion of an example evaporative fuel system 10. It should be understood that other types of systems may be used. The system 10 includes a fuel tank 12 having a fuel filler 14 with a fill cap 16. A fuel pump 18 supplies gasoline, for example, from the fuel tank 12 to an internal combustion engine 20, which provides propulsion to a vehicle. A fuel level sensor 15 is in communication with a controller 40, which may be an engine controller, and measures a level of fuel within the fuel tank 12.

The system 10 is configured to capture and regulate the flow of fuel vapors within the system. In one example type of system (e.g. those used in hybrid vehicles), a fuel tank isolation valve (FTIV) 24 is arranged fluidly between the fuel tank 12 and a charcoal canister 22, which captures and stores fuel vapors for later use by the engine 20. A purge valve 26 is fluidly connected between the canister 22 and the engine 20. In one example, the controller 40 regulates a position of the purge valve 26 during engine operation in response to a purge command from the engine controller 40, for example, to selectively provide the fuel vapors to the engine 20 during fuel combustion to make use of these fuel vapors. The LDM 28 may also have its own controller separate and discrete from the engine controller 40.

Regarding the evaporative emissions system, the integrity of the system 10 must be periodically tested to ensure no fuel vapor leakage. One type of system 10 uses a leak detection module (LDM) 28 (also referred to as a “leak check module”), which can be used to pull a vacuum and/or pressurize the system to determine whether a leak exists, for example, using a pressure transducer (e.g., within the LDM 28). In one example leak test procedure, the purge valve 26 is closed and the leak detection module 28 is used to evacuate or pressurize the system. Another pressure transducer 50 may be used to monitor the pressure of fuel vapors within the fuel tank 12 during other conditions. In one example, a temperature sensor 34 is arranged outside the LDM 28. The temperature sensor 34 may be useful for quantify heat transfer characteristics of the fuel vapor within the fuel tank 12 relative to surrounding atmospheric temperature.

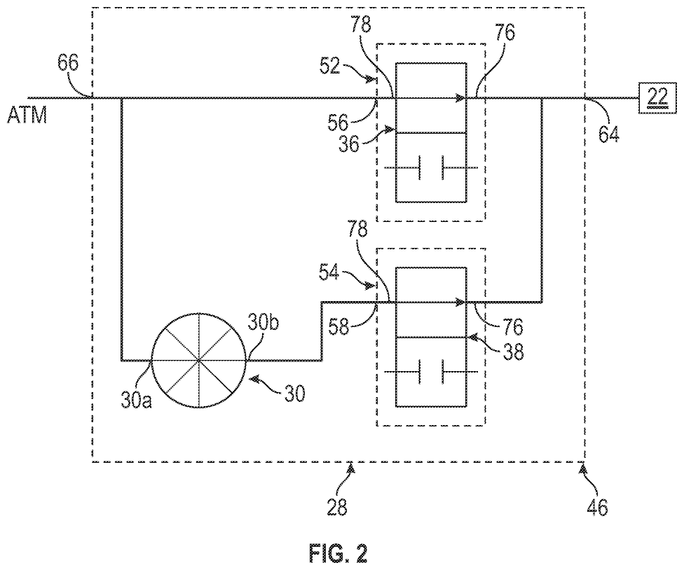

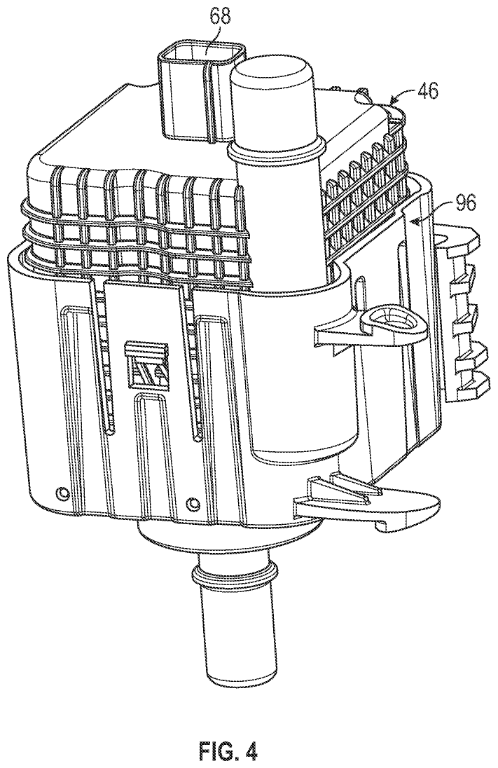

A disclosed example LDM 28 is shown in FIGS. 2-4. The LDM 28 includes a pump 30 (e.g., a vane pump) rotationally driven by an electric motor 31 and arranged in a common housing 46, which is typically provided by a multi-piece plastic structure. The housing 46 typically has two fluid connections or openings: a charcoal canister port 64 fluidly connected to the charcoal canister 22, and an atmospheric port 66 in fluid communication with the atmosphere. A filter (not shown) may be arranged between the atmosphere and the pump 30 to prevent debris from entering the LDM 28. The housing 46 can be mounted in a mounting housing 96 secured to a vehicle.

Some customers prefer a system that operates using a vacuum, while other customers prefer a system that is pressurized. The rotational direction of the pump 30 determines whether the system is pressurized or a vacuum is applied. So, to provide a pressurized evaporative emissions system test, the pump 30 will draw air from the atmospheric port 66 direct the atmospheric air towards the charcoal canister 22. To provide a depressurized or negative pressure evaporative emissions system test (i.e., vacuum), the pump 30 will draw air from the charcoal canister 22 and out to the atmosphere through the atmospheric port 66.

Generally, when the LDM 28 is not performing a leak check of the fuel system 10, a canister valve solenoid (CVS; e.g., first solenoid valve) 36 and a CVS check valve (e.g., second solenoid valve) 38, which are arranged in the housing 46, are in an open position to allow air to pass between the charcoal canister port 64 and the atmospheric port 66. This enables the system 10 to draw air from the atmosphere (e.g., during vapor purge) or expel air to the atmosphere (e.g., during refueling), as needed. In the example, the first and second solenoid valves 36, 38 are 2-position valves having open and closed positions, and are normally open when the solenoid valves are de-energized. When the LDM 28 is performing a leak test of the of the fuel system 10, the CVS 36 is in a closed position, and the CVS check valve 38 remains in the open position. Once the desired system pressure is reached, both the CVS 36 and CVS check valve 38 are closed. The pressure transducer 32 is arranged to read the pressure in the system.

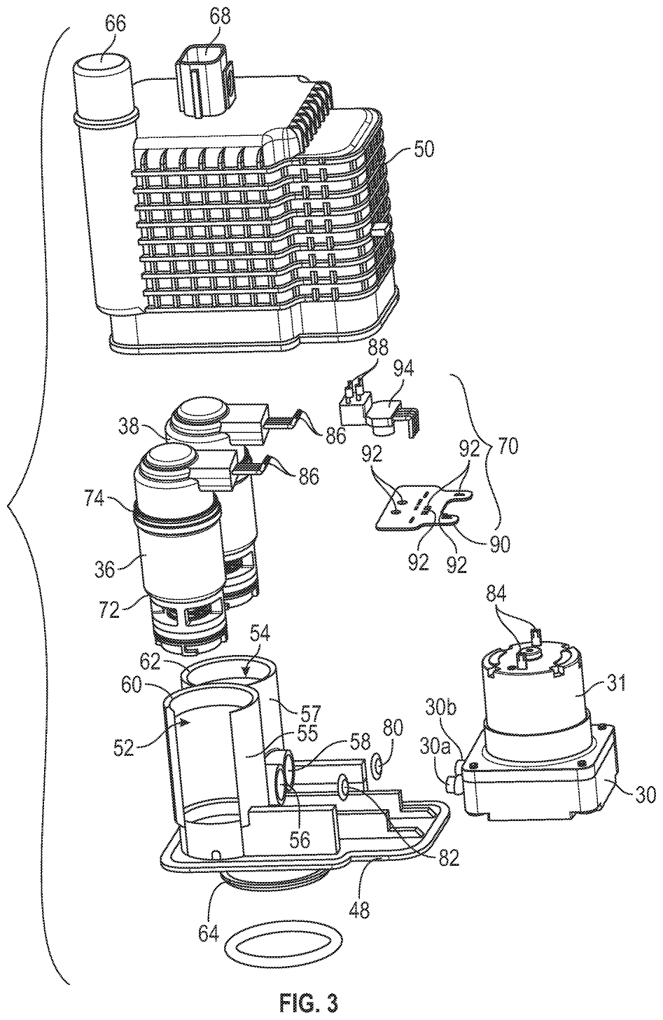

With continuing reference to FIGS. 2 and 3, the housing 46 includes first and second housing portions 48, 50. The first housing portion 48 has first and second valve cavities 52, 54 (e.g., cylindrical apertures) respectively provided by first and second walls 55, 57 that respectively extend to first and second openings 60, 62. The bottom of each of the first and second cavities 52, 54 are in fluid communication with the charcoal canister port 64. The first and second walls 55, 57 are respectively including first and second holes 56, 58.

The first and second solenoid valves 36, 38 are arranged within the housing 46 and are respectively received in the first and second cavities 52, 54, such that they extend out of the first and second openings 60, 62. First and second seals 72, 74 are provided on each of the first and second solenoid valves 36, 38 and form a first and second chamber 76, 78 with the respective first and second valve cavities 52, 54. In the example, each of the second chambers 78 is bounded by the first and second valve seals 72, 74. Both of the first chambers 76 of the first and second cavities 52, 54 are in fluid communication with the charcoal canister port 64. At least one of the second chambers 78 of the first and second cavities 52, 54 are selectively in fluid communication with the atmospheric port 66.

The pump 30 is arranged within the housing 46 and has first and second pump ports 30a, 30b respectively coupled to the first and second holes 56, 58. In the example, the first and second pump ports 30a, 30b and the first and second holes 56, 58 are nested relative to one another with a first and second seal 80, 82 respectively therebetween.

The pump 30 includes pump electrical terminals 84 extending in a first direction F (FIG. 8) The first and second solenoid valves 36, 38 include valve electrical terminals 86 that also extend in the first direction F. An electrical connector assembly 70 is arranged within the housing 46 and has electrical connector terminals 88, extending in the first direction F, that cooperate with the electrical connector 68 provided in the second housing portion 50. The electrical connector assembly 70 includes a printed circuit board (PCB) having traces with slots 92 that electrically engage the upward-turned pump and valve electrical terminals 84, 86 when the PCB 90 is pushed onto the pump 30 and solenoid valves 36, 38 in the insertion direction I. A separate subassembly 94 may provide the electrical connector terminals 88 (e.g. FIG. 3), if desired.

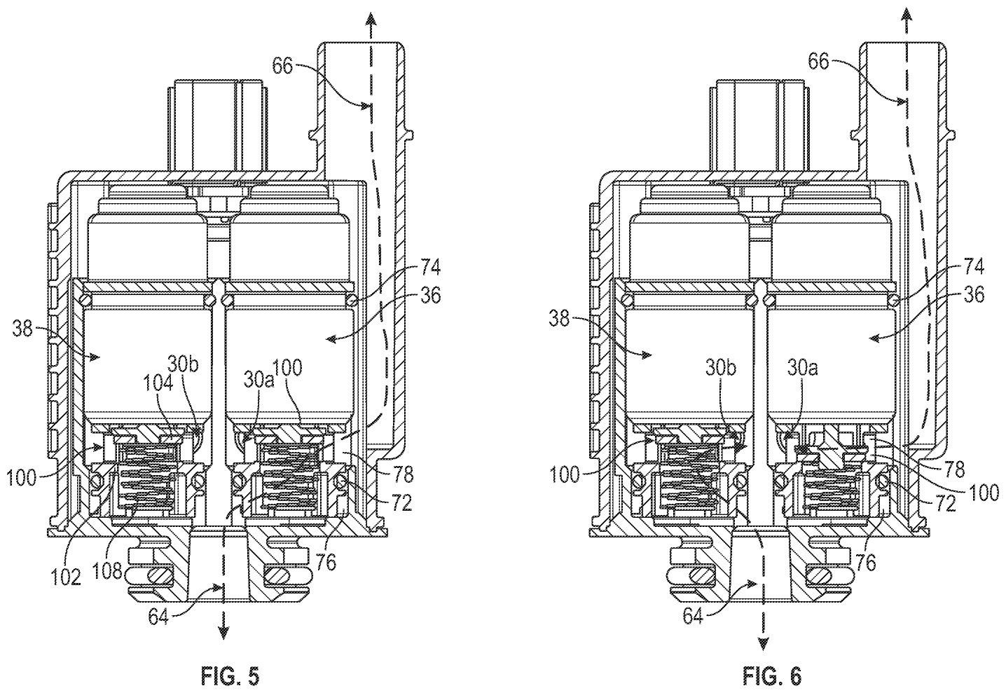

Referring to FIGS. 5-7, each of the first and second solenoid valves 36, 38 are configured to fluidly connect its respective first and second chambers 76, 78 of the its respective first and second valve cavity 52, 54 when in the open position. The solenoid valves 36, 38 include a poppet valve 100 having a seal 104 that abuts a seat 102 when in a closed position. A spring 106 acts on the valve 100 to bias the valve to the open position when the solenoid valve is de-energized.

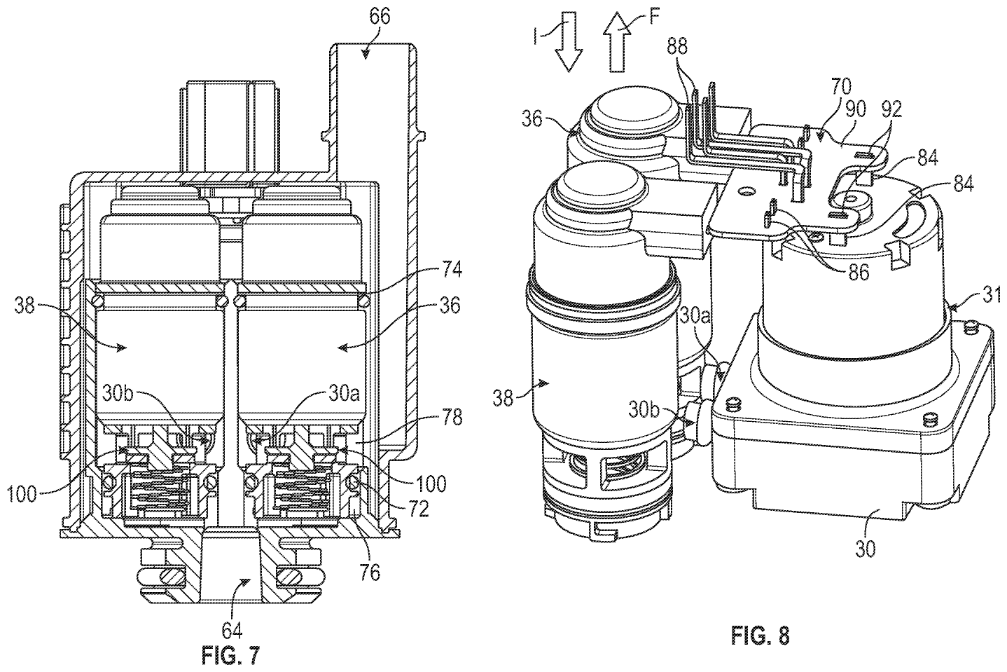

The LDM 28 includes three operational states including first state corresponding to a non-operational state in which both the first and second solenoid valves 36, 38 are open (FIG. 5). In a second state (a pressure mode during a testing state), the first solenoid valve 36 is closed and the second solenoid valve 38 is open (FIG. 6), and the first solenoid valve 36 fluidly blocks the fluid flow between the charcoal canister port 64 and the atmospheric port 66 via the first chamber 76 of the first valve cavity 52. In this second state, the pump 30 is configured to move fluid between the canister and atmospheric ports 64, 66. A third state (FIG. 7) corresponds to a pressure-hold mode during the testing state in which the both the first and second solenoid valves 36, 38 are closed. The internal pressure of the system is monitored for leaks. An OBDII system 42 communicates and/or is integrated with the engine controller 40 and uses the pressure information to generate engine malfunction codes that may be stored and for illuminating a “check engine” light on the vehicle instrument panel indicating vehicle service is needed.

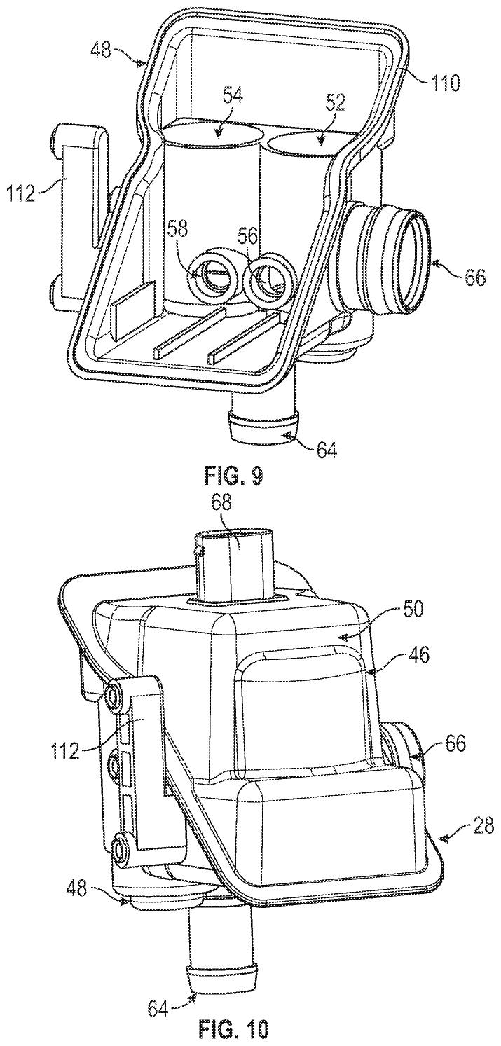

Another example LDM 28 is shown in FIG. 8-10. The configuration is similar to that shown in FIGS. 2-7, but the housing 46 has been modified for packaging. The first and second housing portions 48, 50 are secured to one another at a perimeter 110, and a bracket 112 has been integrated into the housing 46.

A method of assembling the LDM 28 includes inserting the first and second solenoid valves 36, 38 in an insertion direction I (FIG. 8) respectively through first and second openings 60, 62 into first and second valve cavities 52, 54 of the first housing portion 48. The first and second valve cavities 52, 54 respectively are provided by the first and second walls 55, 57, which respectively include first and second holes 56, 58. Once inserted, first and second valve seals 72, 74 carried by each of the first and second solenoid valves 36, 38 are seated against its respective first and second valve cavity 52, 54 to form first and second chambers 76, 78.

The pump 30 with its first and second pump ports 30a, 30b are respectively inserted (e.g., simultaneously) into the first and second holes 56, 58 in a transverse direction to the insertion direction I by pushing, which seats the first and second pump seals 80, 82.

An electrical connector assembly 70 is pushed onto the pump electrical terminals 84 and the valve electrical terminals 86 (e.g., simultaneously) by pushing the PCB 90 in the insertion direction I.

The second housing portion 50 is secured to the first housing portion 48 to enclose the first and second solenoid valves 36, 38, the pump 30, motor 31, and the electrical connector assembly 70. In one example, during the securing step the electrical connecter terminals 88 are inserted into the electrical connector 68 provided on the second housing portion 50.

The controller 40 and OBDII system 42 may be integrated or separate. In terms of hardware architecture, such the controllers can include a processor, memory, and one or more input and/or output (I/O) device interface(s) that are communicatively coupled via a local interface. The local interface can include, for example but not limited to, one or more buses and/or other wired (e.g., CAN, LIN and/or LAN) or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controllers may be a hardware device for executing software, particularly software stored in memory. The processor can be a custom made or commercially available processor, a central processing unit (CPU), an auxiliary processor among several processors associated with the controllers, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, etc.). Moreover, the memory may incorporate electronic, magnetic, optical, and/or other types of storage media. The memory can also have a distributed architecture, where various components are situated remotely from one another, but can be accessed by the controller.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

When the controllers are in operation, its processor can be configured to execute software stored within the memory, to communicate data to and from the memory, and to generally control operations of the computing device pursuant to the software. Software in memory, in whole or in part, is read by the processor, perhaps buffered within the processor, and then executed.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples. For example, the disclosed pump may be used in applications other than vehicle evaporative systems.

Although an example embodiment has been disclosed, a worker of ordinary skill in this art would recognize that certain modifications would come within the scope of the claims. For that reason, the following claims should be studied to determine their true scope and content.

What is claimed is:

1. A leak detection module (LDM) comprising:
a housing including first and second valve cavities respectively having first and second walls respectively extending to first and second openings, the first and second walls respectively including first and second holes, the housing having an atmospheric port and a charcoal canister port, the housing including an electrical connector;
first and second solenoid valves arranged within the housing respectively received in the first and second cavities and extending out of the first and second openings;
a pump arranged within the housing having first and second pump ports respectively coupled to the first and second holes; and
an electrical connector assembly arranged within the housing and coupled to the electrical connector, the electrical connector assembly electrically connected to the first and second solenoid valves, and the pump.

2. The LDM of claim 1, wherein each of the first and second solenoid valves forms a first and second chamber with its respective first and second valve cavity, both of the first chambers of the first and second cavities in fluid communication with the charcoal canister port, and at least one of the second chambers of the first and second cavities selectively in fluid communication with the atmospheric port.

3. The LDM of claim 2, wherein each of the second chambers is bounded by a first and second valve seal arranged between its respective first and second solenoid valve at its respective first and second valve cavity.

4. The LDM of claim 2, wherein the first and second solenoid valves are 2-position valves having open and closed positions, each of the first and second solenoid valves configured to fluidly connect its respective first and second chambers of the its respective first and second valve cavity in the open position, wherein the LDM includes three operational states, comprising:
non-operational state in which both the first and second solenoid valves are open;
a pressure mode during a testing state in which the first solenoid valve is closed and the second solenoid valve is open, the first solenoid valve fluidly blocking the fluid flow between the charcoal canister port and the atmospheric port via the first chamber of the first valve cavity, and the pump is configured to move fluid between the canister and atmospheric ports; and
a pressure-hold mode during the testing state in which the both the first and second solenoid valves are closed.

5. The LDM of claim 2, wherein the first and second pump ports and the first and second holes are nested relative to one another with a first and second seal respectively therebetween.

6. The LDM of claim 1, wherein the housing includes first and second housing portions secured to one another to enclose the first and second solenoid valves, the pump and the electrical connector assembly, the first and second walls and the charcoal canister port provided by the first housing portion, and the electrical connector provided by the second housing portion.

7. The LDM of claim 6, wherein the pump includes pump electrical terminal extending in a first direction, and the first and second solenoid valves include valve electrical terminals extending in the first direction, the electrical connector assembly including an insertion direction opposite the first direction and from which the electrical connector assembly is configured to be pushed into engagement with the pump and valve electrical terminals.

8. The LDM of claim 7, wherein the electrical connector assembly includes electrical connector terminals extending in the first direction and extending into the electrical connector in an assembled position.

9. The LDM of claim 7, wherein the electrical connector assembly includes a printed circuit board (PCB) having slots receiving the pump and valve electrical terminals.

10. A method of assembling a leak detection module (LDM), comprising:
inserting first and second solenoid valves respectively into first and second valve cavities in a first housing portion; the first and second valve cavities respectively provided by first and second walls respectively including first and second holes;
installing a pump having first and second pump ports respectively into the first and second holes;
pushing an electrical connector assembly onto electrical terminals of the first and second solenoid valves, and of the pump; and
securing a second housing portion to the first housing portion to enclose the first and second solenoid valves, the pump and the electrical connector assembly.

11. The method of claim 10, wherein the inserting step is performed in an insertion direction to insert the first and second valves respectively through first and second openings respectively in the first and second walls, wherein each of the first and second solenoid valves include first and second valve seals that are seated against its respective first and second cavity to form first and second chambers in each of the first and second cavities.

12. The method of claim 11, wherein the installing step includes pushing the first and second pump ports respectively together the first and second holes in a transverse direction to the insertion direction.

13. The method of claim 11, wherein the pushing step includes pushing the electrical connector assembly in the insertion direction to simultaneously electrically engage the electrical terminals of the first and second solenoid valves, and of the pump.

14. The method of claim 11, wherein the securing step includes mounting the second housing portion to the first housing portion in the insertion direction, and simultaneously extending electrical connecter terminals into an electrical connector provided on the second housing portion.

15. The method of claim 10, wherein the first housing portion has a charcoal canister port, and one of the first and second housing portions has an atmospheric port;
wherein both of the first chambers of the first and second cavities in fluid communication with the charcoal canister port, and at least one of the second chambers of the first and second cavities selectively in fluid communication with the atmospheric port,
wherein the first and second solenoid valves are 2-position valves having open and closed positions, each of the first and second solenoid valves configured to fluidly connect its respective first and second chambers of the its respective first and second valve cavity in the open position, wherein the LDM includes three operational states, comprising:
non-operational state in which both the first and second solenoid valves are open;
a pressure mode during a testing state the first solenoid valve is closed and the second solenoid valve is open, the first solenoid valve fluidly blocking the fluid flow between the charcoal canister port and the atmospheric port via the first chamber of the first valve cavity, and the pump is configured to move fluid between the canister and atmospheric ports; and
a pressure-hold mode during the testing state in which the both the first and second solenoid valves are closed.
